(19) United States
(12) Patent Application Publication
(10) Pub. No.: US 2016/0324159 A1
(43) Pub. Date: Nov. 10, 2016

(54) PEST CONTROLLING METHOD, COMPOSITION, ELECTROSTATIC SPRAY DEVICE AND USE THEREOF

(71) Applicant: SUMITOMO CHEMICAL COMPANY, LIMITED, Tokyo (JP)

(72) Inventors: Akiko HARADA, Takarazuka-shi (JP); Yoshito TANAKA, Takarazuka-shi (JP); Timothy C. HADINGHAM, Wallingford (GB)

(73) Assignee: SUMITOMO CHEMICAL COMPANY, LIMITED, Tokyo (JP)

(21) Appl. No.: 15/216,224

(22) Filed: Jul. 21, 2016

Related U.S. Application Data
(62) Division of application No. 13/821,292, filed on Mar. 7, 2013.

(30) Foreign Application Priority Data
Sep. 9, 2010 (JP) 2010-201824

(51) Int. Cl. A01N 53/00; B05D 1/04; A01N 25/06

(52) U.S. Cl. CPC A01N 53/00; A01N 25/06; B05D 1/04

(57) ABSTRACT

Disclosed is a composition containing an ester compound represented by formula (1), which composition is electrostatically sprayed to pests or to a place where the pests inhabit.

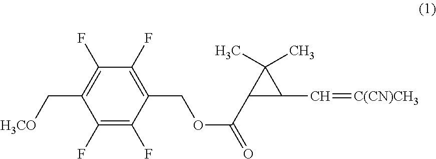

### CROSS-REFERENCE TO RELATED APPLICATIONS

The present application is a divisional application of U.S. patent application Ser. No. 13/821,292, filed Mar. 7, 2013, which is a U.S. national stage application of International Patent Application No. PCT/JP2011/070673, filed Sep. 6, 2011, which claims the benefit of priority to Japanese Patent Application No. 2010-201824, filed Sep. 9, 2010, the entireties of which are hereby incorporated by reference.

### TECHNICAL FIELD

The present invention relates to a method for controlling pests including flying insects, an insecticidal composition, an electrostatic spray device, and use thereof.

### BACKGROUND ART

An ester compound represented by the following formula (1) is known to be effective in controlling insect pests, and is disclosed in Patent Literature 1. In the present specification hereinafter, insects that are targeted for control may be called “pests” as a whole. Moreover, in the specification, “pest control” is a behavioral modification of the pests by repellence, attraction, knock-down or killing. “Effective in controlling” means to dispense the ester compound of an amount that can modify a behavior of the target pest.

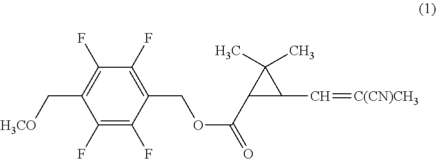

Meanwhile, electrospray by cone jet dispersal of liquids is known in the art (see for example Patent Literature 2, Non Patent Literature 1).

### CITATION LIST

### Patent Literature

Patent Literature 1
U.S. Pat. No. 6,908,945

Patent Literature 2
European Patent Application Publication No. 1399265

### Non Patent Literature

Non Patent Literature 1
Proceedings of the Royal Society—1964, p 383-397

### SUMMARY OF INVENTION

### Technical Problem

The ester compound represented by formula (1) is solid in its pure form, and thus it is difficult to spray the ester compound efficiently. Hence, a method for efficiently spraying to treat pests, and a composition allowing for efficient spraying has been in demand.

The present invention is accomplished in view of such a situation, and an object thereof is to provide a pest controlling method which can effectively carry out pest treatment which does not require heat, applied pressure (e.g. gaseous pressure or mechanical pressure), or smoke fogging for dispersal. Moreover, it is further an object of the present invention to provide a composition which can carry out pest treatment to a wide variety of pests, and is a composition suitable for electrostatic dispersal, for example. It is further an object of the present invention to provide an electrostatic spray device which allows for easy spraying of the composition of the present invention which does not require heat, applied pressure (e.g., gaseous pressure or mechanical pressure) or smoke fogging for dispersal, and allows for treating pests effectively. In addition, it is an object of the present invention to effectively use the composition of the present invention for pest control, without requiring heat, applied pressure (e.g. gaseous pressure or mechanical pressure), or smoke fogging for dispersal of the composition.

### Solution to Problem

As a means for attaining the objects of the invention, a method for controlling pests of the present invention includes electrostatically spraying, to pests or to a place where the pests inhabit, a composition including an ester compound represented by formula (1):

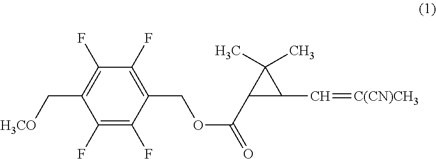

Moreover, as a means for attaining the objects of the invention, a composition of the present invention includes an ester compound represented by formula (1), wherein the ester compound has an electric resistance at 20° C. of not less than 1×10³ Ωm but not more than 1×10⁶ Ωm, a viscosity at 20° C. of not less than 1 mPa·s but not more than 10 mPa·s, and a surface tension at 20° C. of not less than 20 mN/m but not more than 40 mN/m.

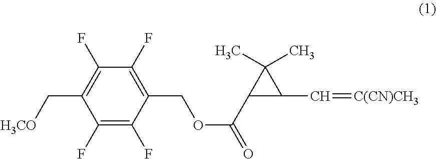

Moreover, as a means for attaining the objects of the invention, an electrostatic spray device of the present invention includes: a reservoir in which the composition is held; a spray electrode into which the composition is fed from the reservoir; and a discharging electrode in a vicinity of the spray electrode, the composition being sprayed from the spray electrode as droplets by applying an electric field between the spray electrode and the discharging electrode.

Moreover, as a means for attaining the objects of the invention, use of the composition of the present invention is use of a composition including: electrostatically spraying a composition to pests or to a place where the pests inhabit, the composition comprising an ester compound represented by formula (1):

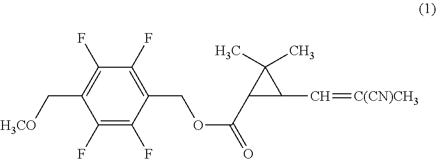

### Advantageous Effects of Invention

According to the controlling method of the present invention, it is possible to effectively carry out pest treatment which does not require heat, applied pressure (e.g. gaseous pressure or mechanical pressure), or smoke fogging for dispersal. Moreover, according to the composition of the present invention, it is possible to carry out pest treatment for a wide variety of pests. Furthermore, according to the electrostatic spray device of the present invention, it is possible to easily spray the composition without requiring heat, applied pressure (e.g. gaseous pressure or mechanical pressure), or smoke fogging for dispersal, and effectively carry out pest treatment. Moreover, according to the use of the composition of the present invention, it is possible to effectively carry out pest treatment without requiring heat, applied pressure (e.g. gaseous pressure or mechanical pressure), or smoke fogging for dispersal.

For a fuller understanding of the nature and advantages of the invention, reference should be made to the ensuing detailed description taken in conjunction with the accompanying drawings.

### BRIEF DESCRIPTION OF DRAWINGS

FIG. 1 is a schematic view illustrating an electrostatic spray device used in spraying a composition of the present embodiment.

### DESCRIPTION OF EMBODIMENTS

Described below is one embodiment of the present invention. The academic literature and patent literature disclosed in the present specification are incorporated by reference into the present specification. Unless particularly described in the present specification, “A to B” representing a numerical range means “not less than A (including and exceeding A) but not more than B (including and smaller than B)”.

A composition according to the present embodiment is, as described later, suitably used in a pest controlling method of the present embodiment, and contains the following compounds: (i) an ester compound represented by formula (1), (ii) a cyclic compound represented by formula (2), and (iii) a bulk carrier component. Among these compounds, the (ii) cyclic compound is optionally comprised by the composition. Moreover, substances selectable as the (iii) bulk carrier component may include a bulk carrier component having physical property modifying functions for adjusting physical properties of the composition, particularly resistivity, viscosity and surface tension (hereinafter, referred to as a physical property modifying component).

(Ester Compound)

The composition of the present embodiment comprises an ester compound represented by formula (1). The ester compound is a compound having excellent control efficacy against pests.

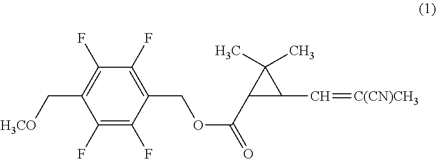

The ester compound of formula (1) (hereinafter, referred to as the present ester compound) is [2,3,5,6-tetrafluoro-4-(Methoxymethyl)phenyl]methyl-3-(2-cyano-1-propenyl)-2,2-dimethylcyclopropanecarboxylate (4-Methoxymethyl-2,3,5,6-tetrafluorobenzyl=3-(2-cyano-1-propenyl)-2,2-dimethylcyclopropanecarboxylate). The present ester compound can be produced by methods disclosed in Japanese Patent Application Publication “Tokukai 2004-2363 A”, U.S. Pat. No. 6,908,945, and like publications.

The present ester compound has isomers (R-configuration, S-configuration, and cis configuration, trans configuration) originated from two asymmetric carbon atoms on the cyclopropane ring, and isomers (E-configuration, Z-configuration) originated from the double bond of substituents on the cyclopropane ring. In the present invention, it is possible to use an ester compound which includes active isomers present in any ratio. The ratio of the isomers is set in accordance with stereoselectivity of reaction that is used in producing the present ester compound. Moreover, a mixture of the isomers, which mixes the isomers in any ratio, may also be used.

The form of the present ester compound may be, for example: [2,3,5,6-tetrafluoro-4-(methoxymethyl)phenyl]methyl=(1R)-3-(2-cyano-1-propenyl)-2,2-dimethylcyclopropanecarboxylate, [2,3,5,6-tetrafluoro-4-(methoxymethyl)phenyl]methyl=(1R)-trans-3-(2-cyano-1-propenyl)-2,2-dimethylcyclopropanecarboxylate, [2,3,5,6-tetrafluoro-4-(methoxymethyl)phenyl]methyl=(1R)-cis-3-(2-cyano-1-propenyl)-2,2-dimethylcyclopropanecarboxylate, [2,3,5,6-tetrafluoro-4-(methoxymethyl)phenyl]methyl=(1R)-trans-3-((E)-2-cyano-1-propenyl)-2,2-dimethylcyclopropanecarboxylate, and [2,3,5,6-tetrafluoro-4-(methoxymethyl)phenyl]methyl=(1R)-trans-3-((Z)-2-cyano-1-propenyl)-2,2-dimethylcyclopropanecarboxylate.

In the ester compound represented by formula (1), a carbon bonding to a carboxyl group on the cyclopropane ring is 1-position, and a carbon bonding to a substituent having a carbon-carbon double bond is 3-position.

Such an ester compound is present in the composition by a proportion of about 0.1% w/w to 10% w/w, for example 0.6% w/w to 8% w/w (e.g. 1.0% w/w to 6% w/w).

(Cyclic Compound)

The composition of the present embodiment may include either one or both of the following compounds:

a first cyclic compound represented by formula (2a):

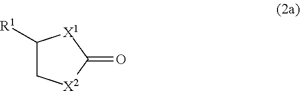

wherein X¹ is an oxygen atom or an alkylimino group having 1 to 8 carbon atoms, X² is a methylene group, an oxygen atom, or an alkylimino group having 1 to 8 carbon atoms, and R¹ is a hydrogen atom or a methyl group, and

a second cyclic compound represented by formula (2b):

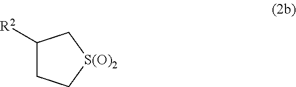

wherein R² is a hydrogen atom or a methyl group.

In the embodiment, the “alkylimino group having 1 to 8 carbon atoms” represented by X¹ and X² in the formula (2a) is, for example, a methylimino group, ethylimino group, propylimino group, butylimino group, pentylimino group, hexylimino group, peptylimino group, or octylimino group.

As the first cyclic compound represented by formula (2a) or the second cyclic compound represented by formula (2b) as described above (hereinafter, referred to as the present cyclic compound), a commercialized compound can be used.

Examples of the present cyclic compound represented by formula (2a) encompass the following compounds:

a compound wherein X¹ is an oxygen atom and X² is a methylene group;

a compound wherein X¹ is an oxygen atom and X² is an oxygen atom;

a compound wherein X¹ is an oxygen atom and X² is an alkylimino group having 1 to 8 carbon atoms;

a compound wherein X¹ is an alkylimino group having 1 to 8 carbon atoms and X² is a methylene group;

a compound wherein X¹ is an alkylimino group having 1 to 8 carbon atoms and X² is an oxygen atom;

a compound wherein X¹ is an alkylimino group having 1 to 8 carbon atoms and X² is an alkylimino group having 1 to 8 carbon atoms;

a compound wherein X¹ is an oxygen atom and X² is a methylene group or an alkylimino group having 1 to 8 carbon atoms;

a compound wherein X¹ is an alkylimino group having 1 to 8 carbon atoms and X² is an oxygen atom or an alkylimino group having 1 to 8 carbon atoms;

(i) γ-butyrolactone, wherein X¹ is an oxygen atom, X² is a methylene group, and R¹ is a hydrogen atom;

(ii) N-methyl-2-pyrrolidone, wherein X¹ is a methylimino group, X² is a methylene group, and R¹ is a hydrogen atom;

(iii) N-ethyl-2-pyrrolidone, wherein X¹ is an ethylimino group, X² is a methylene group, and R¹ is a hydrogen atom;

(iv) N-octyl-2-pyrrolidone, wherein X¹ is an octylimino group, X² is a methylene group, and R₁ is a hydrogen atom;

(v) 1,3-dimethyl-2-imidazolidinone, wherein X¹ is a methylimino group, X² is a methylimino group, and R¹ is a hydrogen atom;

(vi) propylene carbonate, wherein X¹ is an oxygen atom, X² is an oxygen atom, and R¹ is a methyl group; and

(vii) ethylene carbonate, wherein X¹ is an oxygen atom, X² is an oxygen atom, and R¹ is a hydrogen atom.

A particularly suitable compound among these compounds represented by formula (2a) is γ-butyrolactone.

Moreover, as the present cyclic compound represented by formula (2b), one example thereof is a sulfolane (a compound in which R² is a hydrogen atom).

One type of the present cyclic compound may be included in the composition of the present invention, or two or more types thereof may be included in the composition of the present invention.

In the present invention, the weight ratio of the ester compound and the cyclic compound ranges usually 4:1 to 1:300, preferably 3:1 to 1:200, and more preferably 1:1 to 1:100.

Such a cyclic compound represented by formula (2a) or (2b) is typically present in the composition at around 0.4% w/w to 40% w/w, for example 3% w/w to w/w, further 6% w/w to 30% w/w.

(Bulk Carrier Component)

The composition of the present embodiment includes a bulk carrier component which dissolves or disperses the ester compound of formula (1) therein. The bulk carrier component is a solvent or a mixture of solvents, e.g. an organic solvent or mixture of organic solvents. The solvents may be polar or apolar but will typically be polar.

For effective dispersion of the composition in the present embodiment, a stable spray of small droplets should be produced by the electrostatic spray device and the composition must thus ideally satisfy certain constraints. The constraints include: (1) the ability to allow the compound of formula (1) to be uniformly distributed in the composition or otherwise be dissolved in the composition; (2) the composition being characterised by having appropriate resistivity, viscosity, and surface tension, and (3) the bulk carrier component having low toxicity (low risk designations).

As is known in the art, the resistivity, viscosity and surface tension of a composition is primarily dependent on the resistivity, viscosity, surface tension of the solvent and other liquids employed to make the composition. There may be an additional effect on the properties of the composition due to the presence of any dissolved component and additional electrolytes.

Suitably, the bulk carrier component of the composition comprises polyols having at least one hydroxyl group in one molecule, for example ethyl alcohol, propylene glycol, triethylene glycol, glycerin, polyethylene glycol, and polypropylene glycol, and glycol ethers, such as ones including polyol ether e.g. glycol methyl ethers. A particularly suitable polyol ether is dipropylene glycol methyl ether (or (2-methoxymethyloxy)propanol). Other particularly suitable polyol ethers include propylene glycol methyl ether (or 1-methoxy-2-propanol), and tripropylene glycol methyl ether (or 2-(2-methoxymethylethoxy)methylethoxy)propanol).

Further example bulk carrier components include 1-methoxy-2-propanol acetate, 1-butoxy-2-propanol) and 1-proppoxy-2-acetoxypropane, and oxybis(methoxy)propane. Moreover, another example bulk carrier component is ethanol.

The composition contains preferably at least 25 w/w, particularly preferably at least 30% w/w and very particularly preferably at least 31% w/w of the bulk carrier component. In a further preferred embodiment, the composition contains at most 99% w/w, preferably at most 95% w/w, and most preferably at most 89.67% w/w of the bulk carrier component.

The bulk carrier component used in the composition of the present embodiment may be a physical property modifying component. Physical properties of the composition of the present embodiment can be modified by using a plurality of bulk carrier components in combination.

The physical property modifying component may be esters, petrolium (paraffinic, aromatic, naphthenic) solvents (e.g. Isopar L (registered trademark)), silicone oils (e.g. decamethyltetrasiloxane, decamethylcyclopentasiloxane, dodecamethylcyclohexasiloxane and mixtures thereof), polyethylene glycols, water (e.g. HPLC (High performance liquid chromatography)-grade water), and dilute aqueous solutions of electrolytes (e.g. dilute solutions of sodium hydrogen carbonate, sodium acetate, sodium chloride, ascorbic acid, citric acid and acetic acid).

For example, it may be desired to lower the surface tension of the composition by adding an isoparaffin such as Isopar L. The composition may, for example, comprise isoparaffin 0% w/w to 9.99% w/w.

It may be desired to increase the viscosity of the composition by adding a relatively high molecular weight polyethylene glycol, such as polyethylene glycol of molecular weight above 400 Da, e.g. 500 Da to 700 Da.

It may be desired to reduce the resistivity of the composition by adding an electrolyte. Suitable electrolytes are known in the art and include dilute aqueous solutions of alkanoic acid salts, including dilute solutions of sodium acetate (e.g. 0.4% w/w sodium acetate solution).

Furthermore, examples of bulk carrier components which may affect the resistivity include surfactants (nonionic surfactant, amphoteric surfactant, anionic surfactant, cationic surfactant).

The following are examples of surfactants of the composition of the present invention. Examples of nonionic surfactants include sorbitan stearate and sorbitan oleate as sorbitan fatty acid esters; glyceryl stearate, glyceryl isostearate, glyceryl oleate, polyglyceryl stearate, polyglyceryl isostearate, and polyglyceryl oleate as glycerine fatty acid esters; polyoxyethylene lauryl ether, polyoxyethylene cetyl ether, polyoxyethylene stearyl ether, polyoxyethylene oleyl ether, and polyoxyethylene styryl phenyl ether as polyoxyethylene alkyl aryl ethers; polyoxyethylene sorbitan coconut oil fatty acid, polyoxyethylene sorbitan oleate, and polyoxyethylene sorbitan stearate as polyoxyethylene sorbitan fatty acid esters; polyoxyethylene sorbitol tetraoleate as polyoxyethylene sorbitol fatty acid esters; and others such as polyoxyethylene-hydrogenated caster oil and alkylphenol polyglycol ethers.

Examples of the amphoteric surfactant include lauryl betaine and stearyl betain as betaines, and disodium N-lauryl-p-imino-dipropionate as imidazoline derivatives, and others such as lecithin and the like.

Examples of anionic surfactants include: sodium lauryl sulfate, triethanolamine lauryl sulfate and the like as alkyl sulfate; sodium polyoxyethylene lauryl ether sulfate, triethanolamine polyoxyethylene lauryl ether sulfate and the like as polyoxyethylene alkyl ether sulfates; sodium dodecylbenzenesulfonate as alkylbenzene sulfonates; sodium dipolyoxyethylene lauryl ether phosphate, sodium dipolyoxyethylene oleyl ether phosphate and the like as polyoxyethylene alkyl ether phosphates.

Examples of cationic surfactants include: cetyl trimethyl ammonium chloride, distearyl dimethyl ammonium chloride and the like as alkylammonium salt.

Furthermore, it is possible to mix, as a bulk carrier component which may also affect the resistivity of the composition, other salts of quaternary amines, preservatives, salts of chlorhexidine including chlorhexidine digluconate, and other air sanitizers including those disclosed herein.

Measurement of the physical properties of a composition is known to those in the art. Without limiting the ways in which physical properties may be measured:

the resistivity of a composition may be measured by using a liquid resistive cell, by use of a resistivity meter, providing measurement in units of MΩ·m;

the surface tension of a composition may be measured using the Du Noüy Ring method, providing measurements in units of mN/m;

the viscosity of a composition may be measured using a viscometer, providing measurements in unit of mPa·s, which viscometer used may be one which is in conformity with “JIS Z8803 liquid viscosity measurement method”, for example; and

the diameter of droplets of a sprayed composition may be measured using an aerodynamic particle sizer, providing measurements in units of microns.

Needless to say, the physical properties may be measured by other methods.

Suitably the composition may be prepared so as to have the resistivity be in a range of 1×10³ Ωm to 1×10⁶ Ωm at 20° C. Moreover, suitably the composition may be prepared so as to have the viscosity be in a range of 1 mPa·s to 10 mPa·s at 20° C. Furthermore, suitably the composition may be prepared so as to have the surface tension be in a range of 20 mN/m to 40 mN/m at 20° C. By setting the physical values within the foregoing ranges, it is possible to efficiently carry out electrostatic spraying. For example, it is possible to spray the composition well by use of an electrostatic spray device described later.

The composition used in the present invention may further include fragrance or an air sanitizer.

Examples of the fragrances include essential oils and other fragrance oils. The fragrances may be only a part of all fractions (component oils) of these oils.

Preferable examples of the fragrances include Tea tree oil (e.g. oil of Melaleuca, Terpinen-4-ol type), Catmint oil (e.g. oil of Nepeta cateria, refined oil of Nepeta cateria) and fractions thereof (e.g. fractions comprising nepetalactone), Thyme oil (e.g. oil of Thymus vulgaris) and fractions thereof (e.g. fractions comprising thymol).

Fragrances such as the fragrance oils are often mixtures containing plural kinds of compounds with different skeleton chain lengths or mixtures containing plural kinds of stereoisomers. These mixtures may be used.

Among them, the fragrant material is preferably an oil component of at least one oil selected from the group consisting of tea tree oil, Catmint oil, and Thyme oil.

In a case where the composition of the present invention contains the fragrance oil, the content of the fragrance oil is preferably 5 w/w to 35 w/w of the total composition.

Moreover, the fragrance oil preferably has a vapor pressure of 270 Pa at 20° C.

Examples of air sanitizers include active air-cleaner ingredients, active air freshener ingredients, active anti-microbial ingredients, active anti-fungal ingredients, and active anti-allergenic ingredients. To be more specific, preferable examples of the air sanitizers include polyhexamethylene biguanide polymer, polyhexamethyl guanide polymer, n-alkyl dimethyl benzyl ammonium chlorides, octyl decyl dimethyl ammonium chloride, chlorhexidine, chlorhexidine digluconate, benzalkonium chloride, sodium hypochlorite, orthophenylphenol, polyethylene glycol 300, orthobenzylparachlorophenol, 2-phenoxyethanol, glutaraldehyde, phthalaldehyde, chloroxylenol, trichlorophenol, phenol, silver salts (especially water-soluble silver salts), hexachlorophene, peracetic acid, lactic acid, performic acid, potassium permanganate, potassium peroxomonosulphate, n-alkyl dimethyl ethyl benzyl ammonium chlorides, alkyl dimethyl 1-napthylmethyl ammonium chloride, 1,2-benzisothiazolin-3-one, isopropanol, paratertamylphenol, and sodium dodecylbenzen sulphonate.

In a case where the composition of the present invention contains an air sanitizer, the content of the air sanitizer is preferably 0.05% w/w to 20% w/w, more preferably 0.1% w/w to 17% w/w, and particularly preferably 0.1% w/w to 15% w/w of the total composition.

Examples of active anti-microbial ingredients include triclosan, trichloro carbanilide, isopropyl methyl phenol, N-(dichlorofluoromethylthio)-phthalic amide, N′-(dichlorofluoromethylthio)N,N′-dimethyl-N′-phenyl-sulfamide, polyoctyl polyaminoethylglycine, thiabendazole, chlorine dioxide, 2-bromo-2-nitroethanol, 2-bromo-2-nitropropane-1,3-diol, 2 bromo-2-nitropropanol, 1-bromo-1-nitropropanol, 1,4-dibromo-1,4-dinitrobutanediol-2,3-cetylpyrridinium, 1-bromo-1-nitro-2-methylpropanol-2-cetylpyrridinium and cetylpyridinium chloride, benzethonium chloride, acrinol, povidoniodine, mercurochrome, chloramphenicol, fradiomycin sulfate, gentamicin sulfate, oxytetracycline chloride, polymyxin B sulfate, trichomycin, and griseofulvin.

Examples of active anti-fungal ingredients include benzoic acid and salt thereof, sorbic acid and salt thereof, paraoxy benzoic esters, sodium dehydroacetate, propionic acid, polylysine, thiabendazole; terpene alcohols such as linalool, geraniol, nerol, citronellol, α-terpineol, terpinene-4-ol, and isopulegol; alicyclic alcohols having 7-15 carbon atoms such as 2,4-dimethyl-3-cyclohexene-1-methanol, 4-isopropylcyclohexanol, 4-isopropylcyclohexanemethanol, 1-(4-isopropylcyclohexyl)-ethanol, 2,2-dimethyl-3-(3-methylphenyl)-propanol; and arylalkyl alcohols or alkylaryl alcohols having 7-15 carbon atoms such as benzyl alcohol, phenylethyl alcohol, phenylpropyl alcohol, carvacrol, and eugenol.

Examples of active anti-allergic ingredients include hydroxyapatite, epicatechin, epigallocatechin, epicatechin gallate, epigallocatechin gallate, gallic acid and an ester compound of gallic acid and alcohol having 1-4 carbon atoms.

Examples of active air-cleaner ingredients include polyphenol such as tannin and flavonoid (calcone, flavanone, flavanol, flavone, flavonol, isoflavone), cyclodextrin, lauryl methacrylate, geranylchlorinate, 4-hydroxy-6-methyl-3-(4-methyl pentanoyl)-2-pyrone, formalin, glyoxal, sodium bisulfite, sodium sulfite, dihydroxyacetone, 3,5,5-trimethylhexanol, β-ethoxypropionaldehyde, glutaraldehyde, methacrylic ester, maleic ester, maleic monoamide, maleic imide, fumaric ester, β-acyl acrylic acid and salt thereof, citronellol senecionate, 1,3-pentadiene-1-carboxylic alkylester, pinane hydroperoxide, p-cymene peroxide, 1,2-propyleneoxide, 1,2-butyleneoxide, glycidyl ether, saccharose octaacetate, Fe(III)-octacarboxyphthalocyanine, Fe(III)-tetracarboxyphthalocymine, 5-methyl-2-isopropyl-2-hexenal, p-butoxyphenol, catechol, hydroquinone, 4-methylcatechol, 1,2,4-trihydroxybenzene, 3-methylcatechol, 3-methoxycatechol, carnosol, rosmanol, brazilin, hematoxylin, shikonin, myricetin, baicalein, baicalin, citral, vanillin, and coumarin.

Other components may also be included which do not affect the overall nature of the composition. For example, an optical tracer such as Uvitex-OB in amounts up to 50% by weight. The one or more further active ingredients may include further insecticidal compounds, for example pyrethrins, pyrethroids, organic phosphorus compounds, synergists, insect attractants, insect repellents. A further insecticidal compound may be present in the composition at around 0.01-30% w/w.

The composition may include one active ingredient or a mixture of ingredients from one class (e.g. the class of insecticidal compounds—for example pyrethroids could be used in combination) or from a mixture of classes (e.g. and insecticidal compound and a fragrance ingredient). Certain substances may themselves be a mixture of compounds e.g. fragrance oils often contain a mixture of chain lengths and insecticidal compounds may contain a mixture of stereoisomers.

The composition according to the present embodiment may be a composition as shown below.

TABLE 1

| | % w/w |
|---|---|
| (i) ester compound | 0.1-10 |
| (iii) bulk carrier component | 90-99 |
| physical property modifying component, among (iii) | 0.5-25 |

TABLE 2

| | % w/w |
|---|---|
| (i) ester compound | 0.1-10 |
| (ii) cyclic compound | 0.4-40 |
| (iii) bulk carrier component | 50-99.5 |
| physical property modifying component, among (iii) | 0.5-25 |

Alternatively a composition according to the invention comprising a further insecticide may typically be as shown below:

TABLE 3

| | % w/w |
|---|---|
| (i) ester compound | 0.1-10 |
| (ii) cyclic compound | 0.4-40 |
| (iii) bulk carrier component | 0-98.99 |
| physical property modifying component, among (iii) | 0.5-25 |
| insecticide | 0.01-30 |

Moreover, in a case where the composition according to the present embodiment includes the foregoing other ingredients, the composition has the following composition ratios.

First, in a case where the fragrance oil, which is a fragrance ingredient, is included as another ingredient, the composition according to the present embodiment has a composition ratio as shown in the following Table 4:

TABLE 4

| | % w/w |
|---|---|
| (i) ester compound | 0.1-10 |
| (ii) cyclic compound | 0.4-40 |
| (iii) bulk carrier component | 0-97 |
| physical property modifying component, among (iii) | 0.5-25 |
| fragrance oil | 2-60 |

Moreover, in a case where an air sanitization compound is contained as the other contained component, the composition according to the present embodiment has a composition ratio as shown in the following Table 5:

TABLE 5

| | % w/w |
|---|---|
| (i) ester compound | 0.1-10 |
| (ii) cyclic compound | 0.4-40 |
| (iii) bulk carrier component | 15-98.9 |
| physical property modifying component, among (iii) | 0.5-25 |
| air sanitizer | 0.1-20 |

(Pests)

Examples of pests treated by the composition of the present embodiment include arthropods such as insects and acarina, particularly harmful arthropods such as harmful insects and harmful acarina. Specific examples thereof are listed below.

Lepidoptera: Pyralidae such as Chilo suppressalis, Cnaphalocrosis medinalis, Plodia interpunctella, and Ephestia kuehniella; Noctuidae such as Spodoptera litura, Pseudaletia separata, and Mamestra brassicae; Pieridae such as Pieris rapae crucivora; Tortricidae such as Adoxophyes spp.; Carposinidae; Lyonetiidae; Lymantriidae; Antographa; Agrotis spp., such as Agrotis segetum and Agrotis ipsilon; Helicoverpa spp.; Heliothis spp.; Plutella xylostella; Parnara guttata; Tinea pellionella; Tineola bisselliella, etc.

Diptera: Culex spp. such as Culex pipiens pallens and Culex tritaeniorhynchus; Aedes spp. such as Aedes aegypti and Aedes albopictus; Anopheles spp. such as Anopheles sinensis; Chironomidae; Muscidae such as Musca domestica, Muscina stabulans and Fannia canicularis; Calliphoridae; Sarcophagidae; Anthomyiidae such as Delia phatura and Delia antiqua; Tephritidae; Agromyzidae; Drosophilidae; Psychodidae; Phoridae; Simuliidae; Tabanidae; Stomoxyidae; Ceratopogpnnidae, etc.

Blattaria: Blattella germanica, Periplaneta fuliginosa, Periplaneta americana, Periplaneta brunnea, Blatta orientalis, etc.

Hymenoptera: Formicidae such as Camponotus japonicus, Tetramorium tsushimae, Lasius niger, Pachycondyla chinensis, Monomorium intruders, Lasius fuji, Monomorium pharaonis, Formica fusca japonica, Ochetellus glaber, Pristomyrmex punctatus, Pheidole noda, and Linepith ema humile; Vespidae such as Polistes (Polistes chinensis, Polistes riparius, Polistes jadwigae, Polistes rothneyi, Polistes nipponensis, Polistes snelleni, and Polistes japonicus), Vespa mandarinia, Vespa simillima xanthoptera, Vespa analis, Vespa crabro, Vespa ducalis, Vespula flaviceps lewisi, Vespula shidai, and Dolichovespula media; Bethylidae; Tenthredinidae such as Athalia rosae ruficornis, etc.

Siphonaptera: Ctenocephalides canis, Ctenocephalides felis, Pulex irritans, etc.

Anoplura: Pediculus humanus, Phthirus pubis, Pediculus humanus capitis, Pediculus humanus corporis etc.

Psocoptera: psocid

Isoptera: Subterranean termites such as Reticulitermes speratus, Coptotermes formosanus, Reticulitermes flavipes, Reticulitermes hesperus, Reticulitermes virginicus, Reticulitermes tibialis, Heterotermes aureus; drywood termites such as Incisitermes minor; and rottenwood termites such as Zootermopsis nevadensis.

Hemiptera: Delphacidae such as Laodelphax striatellus, Nilaparvara lugens and Sogatella furcifera; Deltocephalidae such as Nephotettix cincticeps and Nephotettix virescens; Aphididae; Pentatomidae such as Nezara antennata, Riptortus clavatus, Eysarcoris lewisi, Eysarcoris parvus, Plautia stali, Halyomorpha mista, Stenotus rubrovittatus, and Trigonotylus caelestialium; Aleyrodidae; Coccidae; Cimicidae such as Cinex lectularius; Tingidae; Psyllidae, etc.

Coleoptera: Attagenus unicolor; Anthrenus verbasci; corn rootworms such as Diabrotica virgifera virgifera and Dabrotica undecimpunctaca howardi; scarabaeidae such as Anomala cuprea and Anomala rufocuprea; Curculionidae such as Sitophilus zeamais, Lissorhoptrus oryzophilus, Anthonomus grandis grandis and Callosobruchus cheninsis; Tenebrionidae such as Tenebrio molitor and Tribolium castaneum; Chrysomelidae such as Oulema oryzae, Phyllotreta striolata and Aulacophora femoralis; Anobiidae; Epilachna spp. such as Henosepilachna vigintioctopunctata; Lyctidae; Bostrychidae; Ptinidae; Cerambycidae; Paederus fuscipes; etc.

Thysanoptera: Thrips palmi, Frankliniella occidentalis, Thrips hawaiiensis, etc.

Orthoptera: Gryllotalpidae, Acrididae, Gryllidae, etc.

Acarina: Pyroglyphidae such as Dermatophagoides farinae and Dermatophagoides pteronyssinus; Arcaridae such as Tyrophagus putrescentiae and Aleuroglyphus oyatus; Glycyphagidae such as Glycyphagus privatus, Glycyphagus domesticus and Glycyphagus destructor; Cheyletidae such as Cheyletus malaccensis, Cheyletus malaccesis and Cheyletus moorei; Tarsonemidae; Chortoglyohidae; Oribatei; Tetranychidae such as Tetranychus urticae, Tetranychus kanzawai, Panonychus citri and Panonychus ulmi; Erythraeidae; Ixodidae such as Haemaphysalis longicornis; Dermanyssidae such as Ornithonyssus sylvairum and Dermanussus galinae; etc.

Scutigeromorpha, Chilopoda such as Scolopendra subspimpes mutilans; Diplopoda such as Oxidus gracilis and Nedyopus tambanus; Armadilldiiidae and Porcellionidae such as Armadillidium vulgare; Gastropoda such as Limax marginatus and Limax flavus; and Araneae such as Nephila clavata, Cheiracanthium japonicum and Latrodectus hasselti; etc.

(Controlling Method, Electrostatic Spray Device, Use of Composition)

The method of controlling pests with the aforementioned composition is to electrostatically spray the aforementioned composition to pests targeted for treatment or to a place where the pests inhabit.

The “place where the pests inhabit” is not just an area in which the pests actually inhabit, but denotes at least areas where the pests passes or moves, and additionally, denotes areas not just areas in which inhabitance or passage is presumable, but also from areas from which pests are desirably repelled.

Suitably the resistivity of the composition is in the range 1×10³ Ωm to 1×10⁶ Ωm at 20° C., the viscosity of the composition is in the range 1 mPa·s to 10 mPa·s at 20° C., and the surface tension is in the range 20 mN/m to 40 mN/m at 20° C.

The electrostatic dispersal can be carried out with an electrostatic spray device. Namely, a step of the electrostatically spraying of the composition is carried out by use of an electrostatic spray device including a spray electrode into which the composition is fed and a discharging electrode in the vicinity of the spray electrode, and is preferably a step in which the composition is fed into the spray electrode and an electric field is applied between the spray electrode and the discharge electrode to spray the composition from the spray electrode to the pests or to the place where the pests inhabit.

Electrostatic spray devices employ an electric field to break up liquid as a cone jet by applying a potential difference between a spray electrode (into which the liquid is fed and ultimately exposed to the electric field), and a reference electrodes somewhere in the vicinity. This type of spraying is well known in the art as described by Sir Geoffrey Taylor in the Proceedings of the Royal Society, 1964, p 383-397.

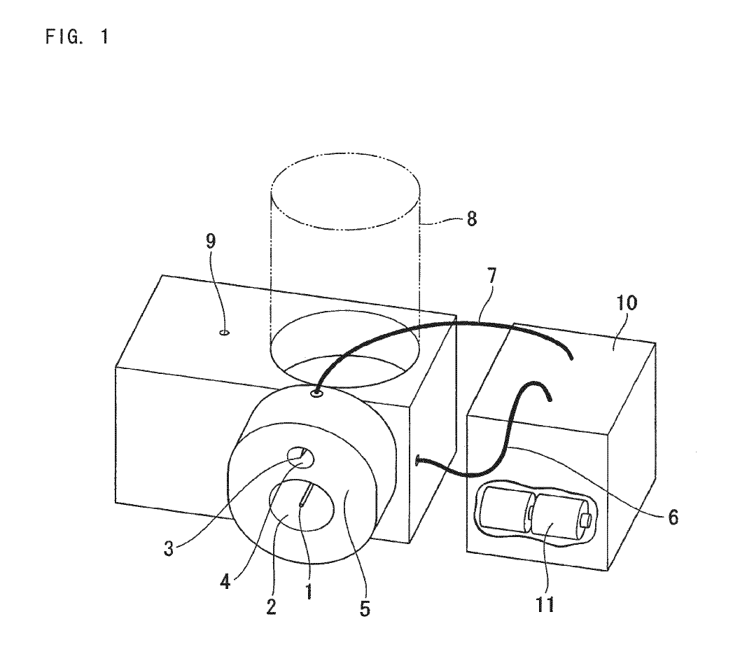

An example of a suitable electrostatic spray device is the device described in EP-A-1399265 (International Publication WO 03/000431), and is exemplified with reference to FIG. 1.

In the electrostatic spray device illustrated in FIG. 1, a cylindrical spray electrode 1 is housed inside a spray recess 2 opened on a side surface (spray outlet surface 5) of the body of the electrostatic spray device, and a discharging electrode 3 paired with the spray electrode 1 is housed inside a discharging recess 4 that similarly is opened on a side surface of the body of the electrostatic spray device (spray outlet surface 5). Charged composition is sprayed from the spray electrode 1, which forms atomized particles of the composition. Meanwhile, an opposite charge to the atomized particles of the composition is applied to the discharging electrode 3, thereby attracting the sprayed atomized particles to the discharging electrode 3. As a result, this influences the direction of flow of the atomized particles. The spray electrode 1, for example, comprises a 27-gauge metal or conductive plastic capillary and the discharging electrode 3 comprises a sharp, stainless steel pin, 0.6 mm in diameter.

The spray recess 2 and the discharging recess 4 are perpendicular to the spray outlet surface 5, which spray outlet surface 5 is made of dielectric material. In this example, the material is polypropylene and the spray outlet surface 5 is flat. However, other materials and curved surfaces can be used provided that there is sufficient charge retention at the spray outlet surface 5 to deflect the composition sprayed from the cylindrical spray electrode 1 and charge carriers away from the device and electrodes.

The spray electrode 1 and the discharging electrode 3 are electrically connected to a driving circuit 10 (which is powered by batteries) via sheathed metal conduits 6 and 7. One of the electrodes may serve as a positive electrode and the other of the electrodes may serve as a negative electrode (e.g. the spray electrode 1 as the positive electrode, and the discharging electrode 3 as the negative electrode).

The composition to be sprayed is held in a reservoir 8, and the composition is fed into the spray electrode 1 via a pump and/or pipe (not illustrated). Moreover, the reservoir 8 is connected to the outside via a small air inlet hole 9 so that its inside is not negatively pressured as a result of the feeding of the composition to the spray electrode.

According to such an electrostatic spray device, first, the composition is fed into the cylindrical spray electrode 1 from the reservoir 8, and a high voltage is applied to the composition at the spray electrode 1. As described above, the composition is charged since the composition has resistivity in a predetermined range, and the composition is sprayed from the tip of the spray electrode 1 caused by electrostatic force. The atomized composition is charged by the electric charge applied at the spray electrode 1, and hence is atomized by breaking up into air by repulsion caused by coulomb force. The composition is well atomized and broken up since it has a viscosity in a predetermined range and a surface tension in a predetermined range.

When this device is energised by the driving circuit 10, for instance by insertion of batteries or through the action of an internal electronic timer, liquid from the reservoir 8 is emitted from the spray electrode 1 in a very fine form, such that it quickly evaporates according to its vapour pressure and the ambient conditions in the vicinity of the device. The amount emitted may be determined in accordance with an effective amount of the ester compound against the targeted pests.

An electrostatic spray device may be adapted to dispense a composition according to the present invention in an occasional manner (e.g. using a duty cycle) or continuously. Dose rate may be, for example, up to 5 g (e.g. up to 3 g) of composition per day although such a level should not be seen as limiting.

It is a common limitation of the electrostatic spray device as such that composition components with low volatility become deposited on or about the spray electrode. When this happens, the spray electrode may become partially occluded or even blocked, resulting in inefficient or ineffective spraying. This is particularly true when the spray electrode is a capillary from which liquid to be sprayed is issued. It is an advantage of the invention that the composition of the present embodiment provides a stable spray with little or no deposition on or about the spray electrode when sprayed for 14 days in a duty cycle of spraying for 25 seconds in 2 minutes, even at relatively high concentrations of the ester compound (e.g. 1.2% w/w of ester compound).

The efficiency of dispersion of a composition may be determined qualitatively by examination of proximal deposition by visual inspection of the spray device and for production of a fine plume of sprayed matter.

Effects of pest control with use of such an electrostatic spray device may be determined through a range of means known to one skilled in the art. For example, it is possible to quantitatively analyze a time required for 50% of a population of pests to be knocked down (KD50) or killed (KT50) in a test chamber of known dimensions (e.g. a Peet-Grady chamber). Quantification of chronic proximal deposition may be determined by swabbing the proximity of the spray device and examination by method appropriate to the type of tracer used (e.g. HPLC or spectrophotometry). Chronic mass loss may be determined by monitoring variation in weight.

As a result, it is possible to electrostatically spray the composition, which is solid at room temperature, to pests or to a place where the pests inhabit. Accordingly, the following effects may be obtained.

Namely, according to the controlling method of the present embodiment, it is possible to immediately start or stop the spraying of the ester compound without requiring heat or applied pressure (e.g. gaseous pressure or mechanical pressure), or smoke fogging for dispersal of the composition, by spraying, with use of electrostatic dispersal, a composition including an ester compound represented by formula (1), which composition is a solid under standard air pressure. This makes it easy to control the amount of the ester compound sprayed, and allows for preventing wasting of the ester compound. Hence, according to the controlling method of the present embodiment, it is possible to effectively treat pests.

Moreover, in the controlling method of the present embodiment, the resistivity, viscosity, and surface tension of the composition that includes the ester compound represented by formula (1) are set as a value in a predetermined range. This allows the composition to have physical properties suitable for electrostatic dispersal. As a result, it is possible to positively spray the composition to treat the pests.

Moreover, the controlling method of the present embodiment allows for positively spraying the composition by use of a device suitable for electrostatic dispersal.

Moreover, according to the composition of the present embodiment, the composition including the ester compound represented by formula (1), which composition is a solid under standard pressure, has its resistivity, viscosity, and surface tension set as a value in a predetermined range. This allows for the composition to be dispersed into the air over a wide area, which makes it possible to effectively treat various pests.

Moreover, an electrostatic spray device of the present embodiment allows for easy spraying of the composition, without requiring heat or applied pressure (e.g. gaseous pressure or mechanical pressure), or smoke fogging for dispersal. Since it is easy to control the sprayed amount of the composition, it is possible to avoid any wasting of the ester compound, which is the active component. This as a result allows for accomplishing an electrostatic spray device that can effectively treat pests.

A further advantage of the invention is that the pest treatment may be applied acutely or chronically, reducing wastage of ingredients and permitting treatment according to circumstances. In prior art treatments, acute treatment might only be permitted by dispersal of composition upon actuation of an aerosol dispenser. Actuation of the aerosol dispense may be manual or mechanical according to a mechanical timer. The resulting aerosol spray is often polydisperse with the consequence of inefficient delivery of spray droplets to the pest or pest habitat. Chronic or constant emanation treatments are typically achieved by volatilisation of active ingredient. The ester compound represented by formula (1) is solid under normal atmospheric pressure and therefore requires heating or adsorption onto smoke condensates in order to be dispersed as a chronic or constant emanation treatment. There may be considerable lag in initiation of heating and effective volatilisation. Likewise, there may be considerable lag in stopping volatilisation as a heated or smoking dispersal means cools to the extent that there is no further volatilisation.

Moreover, the composition of the present embodiment may be delivered as an acute treatment or as a chronic treatment without the requirement to reformulate the composition.

Moreover, the composition of the present embodiment may be used for treating pests by electrostatically spraying the composition to the pests or to the place where the pests inhabit. By using the composition as such, it is possible to effectively carry out pest control.

A further advantage of the invention is that a superior pest treatment is achieved compared to common pest treatments of the art, which may permit the amount of pest control active ingredient dispersed in the treatment to be reduced to achieve a comparable effect as the treatments of the art or the relative concentration of the same active ingredient to be reduced in the composition of the invention. An advantage of reducing the amount of pest control active ingredient required to be dispersed or the reducing the relative concentration of the active ingredient is that there is a consequential reduction in the amount of potentially hazardous chemicals to which humans or the environment are exposed.

A further advantage of the invention is that pest treatment may be achieved without exposure to nuisance smoke from a smoking coil impregnated with the active ingredient or risk of harm from pressurized propellants.

The present invention is not limited to the configurations described above, but may be altered within the scope described in the specification. An embodiment based on a proper combination of technical means disclosed in different embodiments is encompassed in the technical scope of the present invention. Further, the literature cited in this specification is of assistance as references in this specification. Hereinafter, the present invention is further described in detail with reference to Examples, however the present invention is not limited to these Examples.

### EXAMPLES

The following describes the present invention in accordance with Examples. Note that the present invention is not limited to these Examples.

In the present Example, knocked-down rates of flying insects (common houseflies, Musca domestica) in a test chamber (1.8 m×1.8 m×1.8 m) were compared. In the present Example, 100 adult Musca domestica houseflies were released in a test chamber which has been subjected to pest control by methods described in Examples or Comparative Examples later described. Results were recorded 15 minutes after releasing the houseflies to determine the knocked-down rate, which knocked-down rate was obtained by observing a proportion of the houseflies that were knocked down during the 15 minutes. In the test, the knocked-down rate was determined by calculating an average value of a double test.

### Example 1

The composition of Example 1 was prepared with the following formulation.

TABLE 6

| | Content (% w/w) |
|---|---|
| Ester compound of formula (1) | 1.2 |
| γ-butyrolactone | 4.8 |
| (2-methoxymethylethoxy)propanol (Dowanol DPM | 84.5 |
| (registered trademark)) | |
| Isoparaffin (IsoparL (registered trademark)) | 8 |
| Water (HPLC-grade) | 1.494 |
| Sodium acetate | 0.006 |
| Total | 100 |

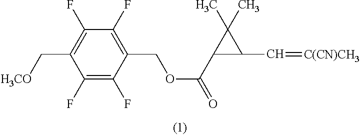

In the present Example, [2,3,5,6-tetrafluoro-4-(Methoxymethyl)phenyl]methyl=(1R)-trans-3-(2-cyano-1-propenyl(E/Z=1/9))-2,2-dimethylcyclopropanecarboxylate was used as the ester compound of formula (1).

The composition shown in Table 6 was dispensed into a reservoir of an electrostatic spray device disclosed in EP-A-1399265 (Cleanaer model, Atrium Innovation Ltd.). The electrostatic spray device was set inside the test chamber. The composition was continuously sprayed for the first 2 minutes immediately after the power was turned on, and thereafter the device was actuated at a duty cycle in which the composition was sprayed for 25 seconds per 2 minutes, to dispense 25 mg of the composition into the chamber. Further performance of the device was terminated thereafter. This treated the inside of the test chamber.

Thereafter, 100 adult Musca domestica (50 males and females) houseflies were released in the test chamber. Results were recorded 15 minutes after releasing the houseflies, to determine the knocked-down rate.

### Comparative Example 1

0.5 g of base material of an insecticidal coil (Union Insecticide Co., Inc.) was uniformly impregnated with 0.25 ml of an acetone solution of [2,3,5,6-tetrafluoro-4-(Methoxymethyl)phenyl]methyl=(1R)-trans-3-(2-cyano-1-propenyl(E/Z=1/9))-2,2-dimethylcyclopropanecarboxylate. In the Comparative Example, the base material was uniformly impregnated so that the base material contained 0.2% w/w of the ester compound.

The resultant base material was air dried to obtain an insecticidal coil. The insecticidal coil was set on a holder placed in the center of the bottom of a test chamber. The insecticidal coil was ignited at one end. The combustion of the coil was completed, thus treating the test chamber.

Subsequently, 100 adult Musca domestica (50 males and females) houseflies were released in the test chamber. Results were recorded 15 minutes after releasing the houseflies, to determine the knocked-down rate.

### Comparative Example 2

To an aerosol can, 0.04 parts of [2,3,5,6-tetrafluoro-4-(Methoxymethyl)phenyl]methyl=(1R)-trans-3-(2-cyano-1-propenyl(E/Z=1/9))-2,2-dimethylcyclopropanecarboxylate, 0.16 parts of γ-butyrolactone, and 59.8 parts of isoparaffin (Isopar M (registered trademark)) were fed, a valve part was attached to the can, and 40 parts of propellants (liquified petroleum gas) were filled through the valve section, to obtain an aerosol containing 100 parts (hereinafter referred to as Comparative Example 2).

Subsequently, 100 adult Musca domestica (50 males and females) houseflies were released in the test chamber.

Thereafter, 750 mg of Comparative Example 2 was sprayed inside the test chamber. Results were recorded 15 minutes after the spraying process, to determine the knocked-down rate.

The results of Example 1 and Comparative Examples 1 and 2 are as shown in Table 7.

TABLE 7

| | % insects knocked-down after |
|---|---|
| Samples | 15 minutes exposure |
| Example 1 | 98 |
| Comparative Example 1 | 8 |
| Comparative Example 2 | 75 |

As a result of the measurement, it was found that Example 1 demonstrated a higher knocked-down rate as compared to Comparative Examples 1 and 2, by which demonstrating that Example 1 can carry out pest control with high efficiency. This confirmed the usability of the present invention.

### Examples 2 and 3

Compositions of Examples 2 and 3 were prepared with the following formulation:

TABLE 8

| | Content (% w/w) | |
|---|---|---|
| | Example 2 | Example 3 |
| Ester compound of formula (1) | 0.6 | 0.6 |
| γ-butyrolactone | 2.4 | 2.4 |
| Dipropylene glycol n-propyl ether | 83 | 83.5 |
| (Dowanol DPnP (registered trademark)) | | |
| Isoparaffin (IsoparL (registered | 8 | 8 |
| trademark)) | | |
| PEG-300 | 4 | 4 |
| Water (HPLC-grade) | 2 | 1.494 |
| Sodium acetate | 0 | 0.006 |
| Total | 100 | 100 |

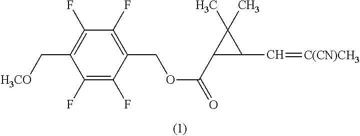

In the present Examples 2 and 3, [2,3,5,6-tetrafluoro-4-(Methoxymethyl)phenyl]methyl=(1R)-trans-3-(2-cyano-1-propenyl(E/Z=1/9))-2,2-dimethylcyclopropanecarboxylate was used as the ester compound of formula (1). Values of physical properties of the compositions of Examples 2 and 3 are as shown below.

TABLE 9

| | Example 2 | Example 3 |
|---|---|---|
| Resistivity: Ωm (20° C.) | 81300 | 20161 |
| Viscosity: mPa · s (20° C.) | 4.84 | 4.64 |
| Surface Tension: mN/m (20° C.) | 28.9 | 29.0 |

The composition shown in Table 9 was fed into the reservoir of the electrostatic spray device disclosed in EP-A-1399265 (Cleanaer model, Atrium Innovation Ltd.). The composition was continuously sprayed for the first 2 minutes immediately after the power was turned on, and thereafter the device was actuated at a duty cycle in which the composition was sprayed for 25 seconds per 2 minutes, to dispense 30 mg of the composition into the chamber. Further performance of the device was terminated thereafter. This treated the inside of the test chamber.

Subsequently, 100 adult Musca domestica (50 males and females) houseflies were released in the test chamber. The number of houseflies that were knocked down were counted from when Musca domestica were released until 15 minutes thereafter. This obtained a KT50 value (average of 6 repetitive tests).

The results of Examples 2 and 3 are as shown in the following Table.

TABLE 10

| | Example 2 | Example 3 |
|---|---|---|
| KT50 (mins) | 11 | 9.4 |

### INDUSTRIAL APPLICABILITY

With the present invention, it is possible to effectively carry out pest control. Hence, the present invention is usable in various industries which suitably uses the present pest control technique.

### REFERENCE SIGNS LIST

1 spray electrode
2 spray recess
3 discharging electrode
4 discharging recess
5 spray outlet surface
6 sheathed metal conduit
7 sheathed metal conduit
8 reservoir
9 small air inlet hole
10 driving circuit

1. A method of controlling a pest comprising:
electrostatically spraying, the pest or to a place where the pest inhabits, a composition comprising
(1) an ester compound represented by the following formula (1): 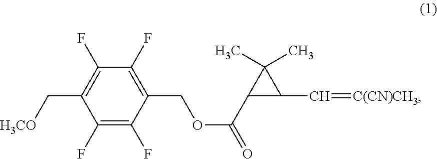
(2) at least one cyclic compound selected from the group consisting of
a first cyclic compound represented by formula (2a): 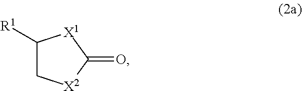
wherein X¹ is an oxygen atom or an alkylimino group having 1 to 8 carbon atoms, X² is a methylene group, an oxygen atom or an alkylimino group having 1 to 8 carbon atoms, and R¹ is a hydrogen atom or a methyl group, and
a second cyclic compound represented by formula (2b): 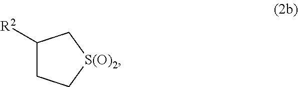
wherein R² is a hydrogen atom or a methyl group, and
(3) dipropylene glycol n-propyl ether.

2. The method according to claim 1, wherein the composition has a resistivity at 20° C. of not less than 1×10³ Ωm but not more than 1×10⁶ Ωm, a viscosity at 20° C. of not less than 1 mPa·s but not more than 10 mPa·s, and a surface tension at 20° C. of not less than 20 mN/m but not more than 40 mN/m.

3. The method according to claim 1, wherein
the electrostatically spraying of the composition is performed with an electrostatic spray device comprising (i) a spray electrode into which the composition is fed and (ii) a discharging electrode provided in a vicinity of the spray electrode,
the electrostatically spraying of the composition comprising:
(a) feeding the composition into the spray electrode; and
(b) applying an electric field between the spray electrode and the discharging electrode, to spray the composition to the pests or to the place where the pests inhabit.

4. The method according to claim 1, wherein
the at least one cyclic compound is the first cyclic compound represented by formula (2a).

5. The method according to claim 1, wherein the at least one cyclic compound is the second cyclic compound represented by formula (2b).

6. The method according to claim 1, wherein the cyclic compound is γ-butyrolactone.

7. The method according to claim 1, wherein the cyclic compound is propylene carbonate.

8. The method of claim 1, wherein the composition comprises
about 0.1% w/w to 10% w/w of the ester compound represented by formula (1),
about 3% w/w to 35% w/w of the cyclic compound represented by formula (2a) or (2b),
about 30% w/w to 95% w/w of a bulk carrier consisting of an organic solvent or mixture of organic solvents, and
0.5% w/w to 25% w/w water.
